(19) United States
(12) Patent Application Publication
(10) Pub. No.: US 2014/0096152 A1
(43) Pub. Date: Apr. 3, 2014

(54) TIMING ADVERTISEMENT BREAKS BASED ON VIEWER ATTENTION LEVEL

(71) Applicants: Ron Ferens, Ramat Hasharon (IL); Gila Kamhi, Zichron Yaakov (IL); Amit Moron, Tel Aviv (IL); Barak Hurwitz, Kibbutz Alonim (IL)

(72) Inventors: Ron Ferens, Ramat Hasharon (IL); Gila Kamhi, Zichron Yaakov (IL); Amit Moron, Tel Aviv (IL); Barak Hurwitz, Kibbutz Alonim (IL)

(21) Appl. No.: 13/631,519

(22) Filed: Sep. 28, 2012

(51) Int. Cl. H04N 21/4415; H04N 21/20

(52) U.S. Cl. 725/12; 725/10

(57) ABSTRACT

A device and method for timing advertisement breaks in video-on-demand applications based on viewer attention level includes a video device configured to display video content and receive biometric data indicative of the attention level of a viewer. The video device may notify a video-on-demand server that the attention level of the viewer has exceeded a threshold. In response to the notification, the video-on-demand server may determine a time to display advertisement content on the video device. The advertisement break time may be determined in relation to the video content. The advertisement content may be selected based on the video content. The video device may determine the viewer attention level during playback of the advertisement content and pause playback if the viewer attention level falls below the threshold.

### BACKGROUND

Video-on-demand systems allow a viewer to request particular video content, which is delivered to the viewer's video device. Video-on-demand applications exist for traditional televisions and set-top boxes, with content delivered through a traditional television distribution system, such as a cable television network. More recently, video-on-demand applications exist for general-purpose computers and mobile devices, delivering content over the Internet or other public data network.

Video-on-demand services may be financially supported through video advertising. Advertising is generally more effective when the displayed advertisements are somehow more relevant to the audience. For example, contextual advertising on the Internet selects advertisements based on the textual content of websites.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for providing advertising break timing based on viewer attention level;

FIG. 2 is a simplified block diagram of at least one embodiment of an environment of a video device of the system of FIG. 1;

FIG. 3 is a simplified block diagram of at least one embodiment of an environment of a video-on-demand server of the system of FIG. 1;

FIG. 4 is a simplified flow diagram of at least one embodiment of a method for timing advertising breaks based on viewer attention level that may be executed by the video device of FIGS. 1 and 2; and

FIG. 5 is a simplified flow diagram of at least one embodiment of a method for timing advertising breaks based on viewer attention level that may be executed by the video-on-demand server of FIGS. 1 and 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

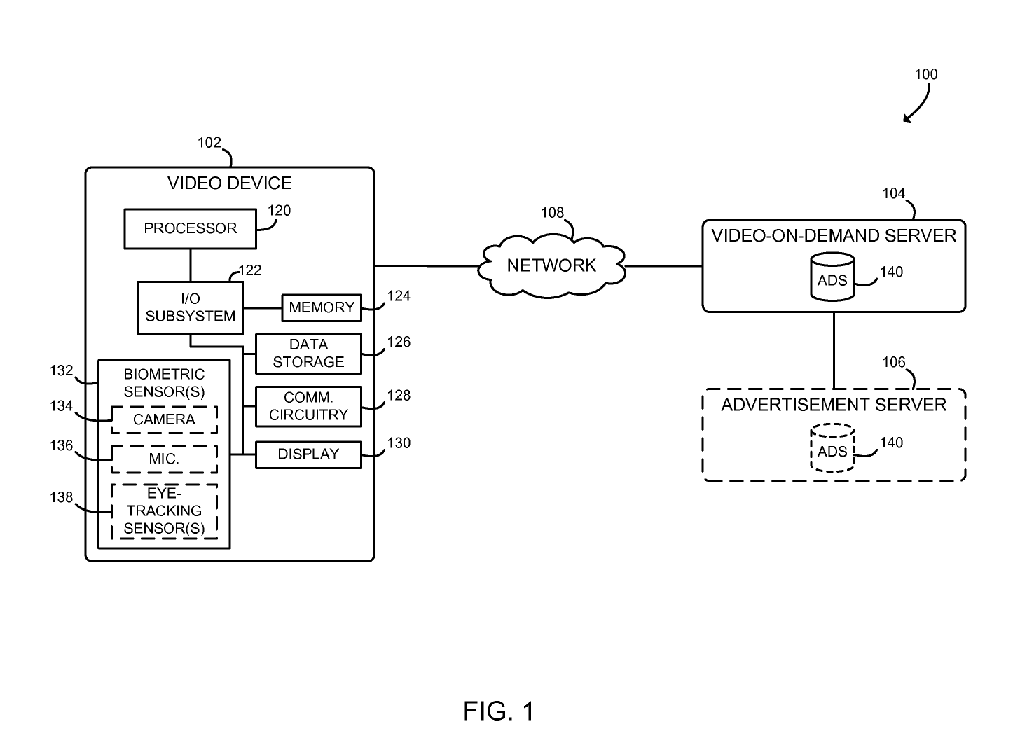

Referring now to FIG. 1, in one embodiment, a system 100 for timing advertisement breaks based on viewer attention level includes a video device 102 and a video-on-demand server 104 in communication with each other over a network 108. In some embodiments, the video-on-demand server 104 may be in communication with an advertisement server 106. In use, as discussed in more detail below, the video device 102 is configured to monitor the attention level of a viewer while playing video content, using biometric data. When the viewer attention level exceeds a threshold attention level, the video device 102 notifies the video-on-demand server 104, and the video-on-demand server 104 may provide advertisement content for display to the viewer. In some embodiments, the advertisement content may be stored and provided by the video-on-demand server 104 alone. In other embodiments, the advertisement content may be stored and provided by the advertisement server 106.

The disclosed advertisement timing method allows advertisers to reach viewers when the viewers are present or paying attention to the displayed advertisement content. Accordingly, advertisements may not be displayed when there is no viewer present to view the advertisement. Thus, the disclosed method may improve the efficiency and effectiveness of advertising campaigns delivered through the video-on-demand medium. By improving advertising effectiveness, the financial viability of advertising-supported video-on-demand services may improve.

The video device 102 may be embodied as any type of device for playing video content to a viewer and performing the functions described herein. In some embodiments, the video device 102 may be embodied as a mobile device such as a smart phone, tablet computer, mobile internet device (MID), notebook computer, laptop computer, portable video player, or other mobile video device. Alternatively, the video device 102 may be embodied as a substantially stationary video device such as a digital television, desktop computer, or other stationary or substantially stationary video device. As shown in FIG. 1, the illustrative video device 102 includes a processor 120, a memory 124, an input/output subsystem 122, a communication circuit 128, a display 130, and a data storage device 126. Of course, the video device 102 may include other or additional components, such as those commonly found in a digital video player and/or computer (e.g., various input/output devices), in other embodiments. Additionally, in some embodiments, one or more of the illustrative components may be incorporated in, or otherwise from a portion of, another component. For example, the memory 124, or portions thereof, may be incorporated in the processor 120 in some embodiments.

The processor 120 may be embodied as any type of processor currently known or developed in the future and capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the video device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the video device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the video device 102, on a single integrated circuit chip.

The communication circuit 128 of the video device 102 may be embodied as any communication circuit, device, or collection thereof, capable of enabling communications between the video device 102 and the video-on-demand server 104 and/or other remote devices. The communication circuit 128 may be configured to use any one or more communication technology (e.g., wireless or wired communications) and associated protocols (e.g., Ethernet, Bluetooth®, Wi-Fi®, WiMAX, etc.) to effect such communication.

The display 130 of the video device 102 may be embodied as any one or more display screens on which information may be displayed to a viewer of the video device 102. The display may be embodied as, or otherwise use, any suitable display technology including, for example, a liquid crystal display (LCD), a light emitting diode (LED) display, a cathode ray tube (CRT) display, a plasma display, and/or other display technology. Although only a single display 130 is illustrated in FIG. 1, it should be appreciated that the video device 102 may include multiple displays or display screens on which the same or different content may be displayed contemporaneously or sequentially with each other.

The data storage device 126 may be embodied as any type of device or devices configured for short-term or long-term storage of data such as, for example, memory devices and circuits, memory cards, hard disk drives, solid-state drives, or other data storage devices. In some embodiments, the video device 102 may store video content or advertisement content in the data storage device 126. For example, the video device 102 may download and store video content or advertisement content for later playback. In other embodiments, the video device 102 may store a portion of the video content or the advertisement content to buffer playback against network interruptions.

In the illustrative embodiment, the video device 102 also includes one or more biometric sensors 132. Such biometric sensors 132 may be embodied as any sensor capable of providing biometric data indicative of the viewer's attention level. For example, in some embodiments, the biometric sensors 132 may include as a camera 134, a microphone 136, and/or eye-tracking sensor(s) 138. The camera 134 may be embodied as a digital camera or other digital imaging device integrated with the video device 102. The microphone 136 may be embodied as any sensor capable of capturing audio signals. The eye tracking sensor(s) 138 may be embodied as any one or more sensors capable of determining an area on the display 130 of the video device 102 on which the viewer's eyes are focused. For example, in some embodiments, the eye tracking sensor(s) 138 may use active infrared emitters and infrared detectors to track the viewer's eye movements over time. The eye tracking sensor(s) 138 may capture the infrared light reflected off of various internal and external features of the viewer's eye and thereby calculate the direction of the viewer's gaze. In some embodiments, the eye tracking sensor(s) 138 may capture additional information relating to the viewer's eyes, such as pupil dilation or blinks. Of course, it should be appreciated that video device 102 may include additional or other biometric sensors in other embodiments, such as electroencephalographic (EEG) sensors, pulse sensors, or other vital signs sensors. Additionally, in the illustrated embodiment, the biometric sensors 132 are components of the video device 102. In other embodiments, the biometric sensors 132 may be included in a separate device in communication with the video device 102, such as an external video camera or an external eye-tracking sensor.

As discussed in more detail below, the video device 102 is configured to transmit and receive data with the video-on-demand server 104 over the network 108. The network 108 may be embodied as any number of various wired and/or wireless networks. For example, the network 108 may be embodied as or otherwise include a wired or wireless local area network (LAN), a wired or wireless wide area network (WAN), and/or a publicly-accessible, global network such as the Internet. As such, the network 108 may include any number of additional devices, such as additional computers, routers, and switches, to facilitate communications between the video device 102 and the video-on-demand server 104.

The video-on-demand server 104 is configured to provide video content and advertising content to the video device 102, as discussed in more detail below. In some embodiments, the advertisement server 106 may be configured to provide advertising content to the video-on-demand server 104 or the video device 102. The video-on-demand server 104 and the advertisement server 106 may be embodied as any type of data servers (e.g., a web server) or similar computing devices capable of performing the functions described herein. As such, the video-on-demand server 104 and the advertisement server 106 may include components and features similar to the video device 102, such as a processor, I/O subsystem, memory, data storage, communication circuitry, and various peripheral devices, which are not illustrated in FIG. 1 for clarity of the present description. The video-on-demand server 104 and the video device 102 may have access to advertisement content 140, which may be stored in data storage of the respective server or may be accessible over a network.

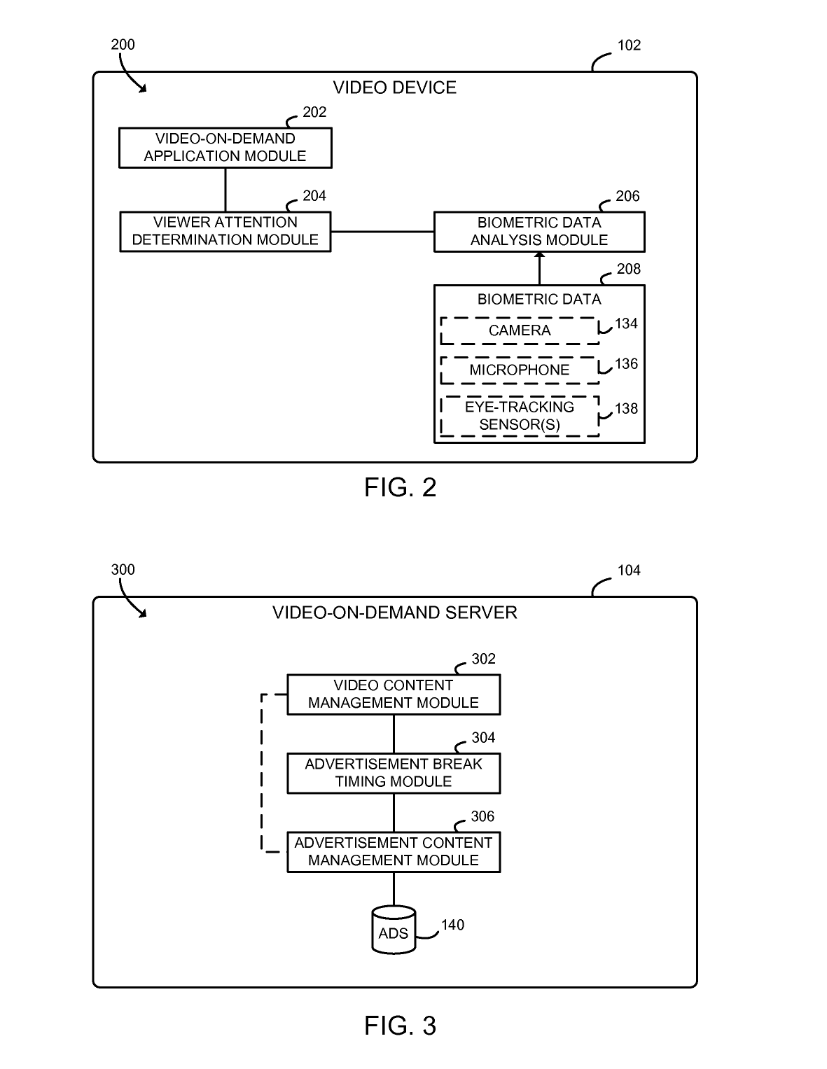

Referring now to FIG. 2, in one embodiment, the video device 102 establishes an environment 200 during operation. The illustrative environment 200 includes a video-on-demand application module 202, a viewer attention determination module 204, and a biometric data analysis module 206 that analyzes biometric data 208. The various modules of the environment 200 may be embodied as hardware, firmware, software, or a combination thereof.

The video-on-demand application module 202 is configured to interact with the viewer by playing video content and receiving viewer input, such as the video-on-demand content requested by the viewer. The video-on-demand application module 202 is further configured to communicate with the video-on-demand server 104 (not shown in FIG. 2), including receiving video content and advertisement content, and notifying the video-on-demand server 104 that the viewer attention level has exceeded the threshold attention level.

The viewer attention determination module 204 is configured to determine the level of the viewer's attention as a function of biometric data received from the biometric data analysis module 206. The viewer attention determination module 204 is further configured to determine when the viewer attention level exceeds a threshold attention level as discussed in more detail below.

The biometric data analysis module 206 is configured to receive and analyze raw biometric data 208 and provide the analyzed biometric data to the viewer attention determination module 204. The biometric data analysis module 206 analyzes and formats the biometric data 208 into a form usable by the viewer attention determination module 204 to determine the attention level of the viewer.

The biometric data 208 is embodied as raw data output from any of the biometric sensor(s) 132. For example, in some embodiments, the biometric data 208 may include image capture data from the camera 134, audio data from the microphone 136, or eye tracking data from the eye-tracking sensor(s) 138. Such biometric data may be analyzed to provide information about the attention level and emotional state of the viewer.

Referring now to FIG. 3, in one embodiment, the video-on-demand server 104 establishes an environment 300 during operation. The illustrative environment 300 includes a video content management module 302, an advertisement break timing module 304, and an advertisement content management module 306. The various modules of the environment 300 may be embodied as hardware, firmware, software, or a combination thereof.

The video content management module 302 is configured to communicate with the video device 102 and provide video content to the video device 102. Video content may be stored locally on the video-on-demand server 104 or may be stored in a remote device accessible to the video-on-demand server 104.

The advertisement break timing module 304 is configured to receive notification from the video device 102 of an advertisement availability, which indicates that the attention level of the viewer has exceeded the threshold attention level. The advertisement break timing module 304 is further configured to determine an advertisement break time based on the notification.

The advertisement content management module 306 is configured to select advertisement content 140 and to serve the advertisement content 140 to the video device 102. In some embodiments, the advertisement content 140 may be stored on the remote advertisement server 106. Such remotely stored advertisement content may be forwarded to the video device 102 by the advertisement content management module 306, or may be accessed directly from the advertisement server 106 by the video device 102.

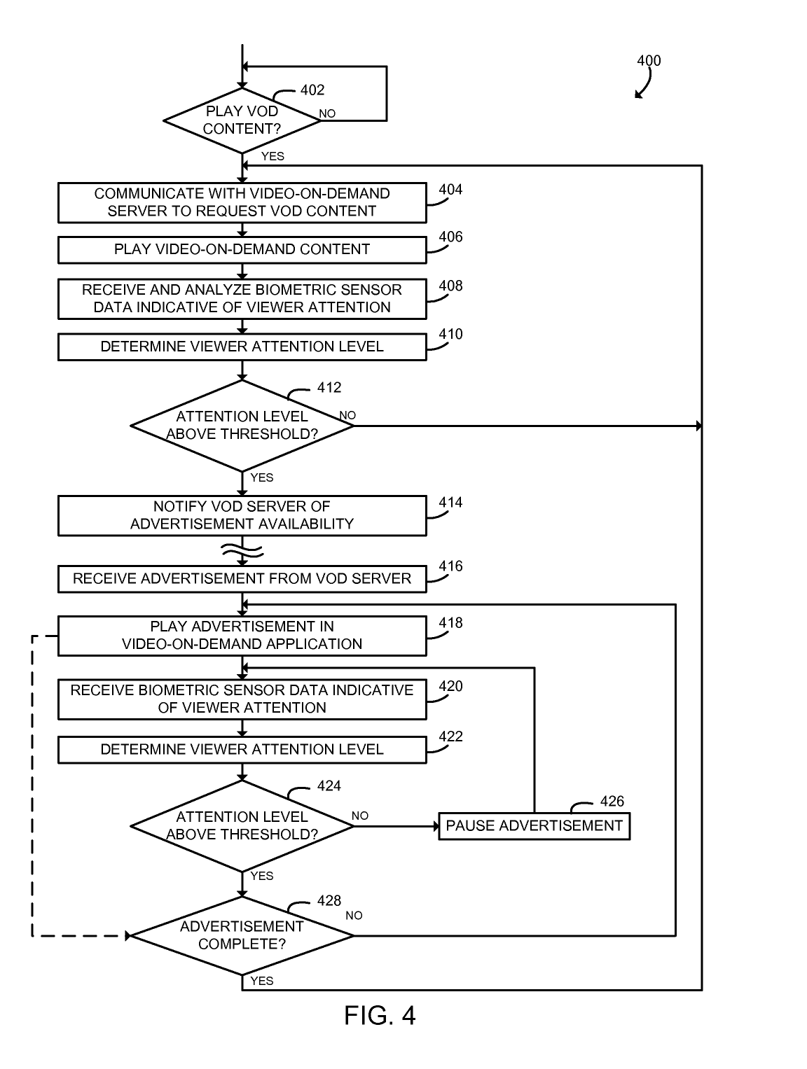

Referring now to FIG. 4, in use, the video device 102 may execute a method 400 for determining viewer attention level and timing advertising breaks based on the viewer attention level. The method 400 begins with block 402, in which the video-on-demand application module 202 determines whether to play video-on-demand content. Such determination may depend on viewer input, as when the viewer selects a video for playback. If the video-on-demand application module 202 determines not to play video-on-demand content, the method 400 loops back and repeats block 402. If the video-on-demand application module 202 determines to play video-on-demand content, the method 400 advances to block 404.

In block 404, the video-on-demand application module 202 communications with the video-on-demand server 104 to request video content. In some embodiments, the requested video content may correspond to an entire video-on-demand program selected by the viewer (e.g., a television show or a movie). In other embodiments, the requested video content may correspond to a segment of such video-on-demand program.

In block 406, the video-on-demand application module 202 plays the video content received from the video-on-demand server 104. In some embodiments, the video-on-demand application module 202 may stream the video content; that is, the video-on-demand application module 202 may play back the video content as the video content is received over the network. In other embodiments, the video-on-demand application module 202 may download and store the entire requested video content before playing back the video content. In some embodiments, the video-on-demand application module 202 may stream the video content and store the streamed video content in a buffer to account for network interruptions or slowdowns.

In block 408, the biometric data analysis module 206 receives and analyzes biometric data 208 indicative of the attention level of the viewer while the video content is being played. As discussed above, the biometric sensor(s) 132 provide raw biometric data 208 to the biometric data analysis module 206. The biometric data analysis module 206 analyzes and formats the raw biometric data 208 into a higher-level form indicative of the user's attention. The analyzed biometric data thus provides information on the user's attention level, engagement, and emotional response to the displayed video content. For example, given raw image capture data from the camera 134, the biometric data analysis module 206 may perform facial recognition analysis on the raw data. In this example, analyzed biometric data may include the number of faces detected and the spatial coordinates of various facial features. The biometric data analysis may be combined or recursive. Continuing the previous example, the analyzed biometric data may be further analyzed to determine facial expressions associated with the spatial coordinates of various facial features.

The biometric data analysis module 206 may perform distinct analysis on biometric data originating from different biometric sensors. For example, given audio data from the microphone 136, the biometric data analysis module 206 may perform speech recognition analysis to determine the contents of words spoken by the viewer. The biometric data analysis module 206 may also analyze the audio data to determine pitch, timbre, or other audio characteristics of the viewer's voice. The biometric data analysis module 206 may further analyze the audio characteristics of the viewer's voice to determine an associated emotional state of the viewer. In another example, given eye-tracking data from the eye-tracking sensor(s) 138, the biometric data analysis module 206 may determine the motion of the viewer's eyes, the dilation of the viewer's pupils, or the number of blinks. The biometric data analysis module 206 may further analyze the eye-tracking data to determine an emotional state of the viewer.

In block 410, the viewer attention determination module 204 determines the attention level of the viewer, using the analyzed biometric data produced by the biometric data analysis module 206. The viewer attention determination module 204 may determine viewer attention level by considering multiple types of biometric data, and each type of biometric data may contribute to the viewer attention level in different ways. The viewer attention level may be represented as a binary value (e.g., paying attention or not paying attention), a value from a set of attention levels (e.g., high, medium, and low attention level), or a numeric representation of viewer attention. For example, the viewer attention determination module 204 may determine a relatively high level of attention based on eye tracking data indicating the viewer is looking at the video content for long, uninterrupted time periods, based on the facial expression of the user indicating interest, or based on speech recognition data indicating the viewer is talking about the video content. Conversely, the viewer attention determination module 204 may determine a relatively low level of attention based on eye tracking data indicating the viewer is not watching the video content, the facial expression of the user indicating boredom, or the facial recognition data indicating the viewer is not present at the video device 102. In some embodiments, the viewer attention level may be determined by combining the various types of biometric data.

In block 412, the viewer attention determination module 204 determines whether the attention level of the viewer exceeds the threshold attention level or otherwise has some predetermined relationship to the threshold attention level (e.g., equals or exceeds, exceeds, etc.). The threshold attention level may be set at any relative level of attention desired for advertising purposes. In some embodiments, the threshold may be set relatively low. For example, the threshold may be exceeded if the viewer is simply present at the video device 102. In other embodiments, the threshold may be set relatively high. For example, the threshold may be exceeded only if the viewer is looking at the video device 102 and biometric data on the viewer's emotional state indicates interest. If the viewer attention level does not exceed the threshold, the method 400 loops back to block 404 and continues to request and play video content from the video-on-demand server 104. Note that in some embodiments, the video content may already be present at the video device 102, in which case the request to the video-on-demand server 104 is not necessary, and the method 400 may loop back to block 406.

Referring back to block 412, if the viewer attention level exceeds the threshold, the method 400 proceeds to block 414. In block 414, the video-on-demand application module 202 notifies the video-on-demand server 104 of an availability for an advertisement. Such notification indicates to the video-on-demand server 104 that the viewer attention level exceeds the threshold and, therefore, the viewer is likely paying attention to the video content. Upon receiving the notification, the video-on-demand server 104 determines a time for an advertisement break, which may be some time in the future.

In block 416, the video-on-demand application module 202 receives advertisement content from the video-on-demand server 104. As discussed above, some time may pass between the notification of advertisement availability discussed in block 414 and the actual delivery of advertisement content. In some embodiments (not illustrated), the video-on-demand application module 202 may receive a command to play advertisement content from the video-on-demand server 104, but the advertisement content may be received from another source, such as the advertisement server 106. In other embodiments, the advertisement content may be stored locally on the video device 102.

In block 418, the video-on-demand application module 202 plays the advertisement content. Such advertisement content is similar to video content: the advertisement content is video content that may be streamed or download in its entirety before being played. In the illustrative embodiment of FIG. 4, the advertisement content is received directly from the video-on-demand server 104. However, in some embodiments, the video-on-demand server 104 may forward the advertisement content from the advertisement server 106. In other embodiments, the video-on-demand application module 202 may receive advertisement content directly from the advertisement server 106, at the direction of the video-on-demand server 104.

In block 420, the biometric data analysis module 206 receives biometric data 208 indicative of the attention level of the viewer while the advertisement content is being played. Block 420 is similar to block 408, and the above discussion of block 408 applies to block 420, except that in block 420, the biometric data analysis module 206 receives and analyzes data during playback of the advertisement content and not the video content.

In block 422, the viewer attention determination module 204 determines the attention level of the viewer, using the analyzed biometric data produced by the biometric data analysis module 206. Block 422 is similar to block 410, and the above discussion of block 410 applies to block 422, except that in block 422 the viewer attention level is determined during playback of the advertisement content, not the video content.

In block 424, the viewer attention determination module 204 the attention level of the viewer exceeds (or matches or exceeds) the threshold attention level. This determination is similar to the determination of block 412, and the same discussion applies, except that in block 424 the determination is made during playback of advertisement content. The threshold attention level of block 424 may be the same as in block 412, or may be different. If the viewer attention level is not above the threshold attention level, the method 400 proceeds to block 426. In block 426, the video-on-demand application module 202 pauses playback of the advertisement content. In some embodiments, instead of or in addition to pausing the advertisement content, the video-on-demand application module 202 may notify the video-on-demand server 104 that the viewer attention level is not above the threshold attention level. Such notification may allow the video-on-demand server 104 to record whether or not the advertisement content has been viewed, which may be used for tracking or billing purposes. After block 426, the method 400 loops back to block 420 to continue receiving biometric sensor data. Referring back to block 424, if the viewer attention level is above the threshold attention level, the method 400 proceeds to block 428.

In block 428, the video-on-demand application module 202 determines whether playback of the advertisement content is complete. If the playback is not complete, the method 400 loops back to block 418 to continue playing the advertisement content and receiving biometric data. If the playback is complete, the method 400 loops back to block 404 to continue requesting video-on-demand content.

The blocks 420 through 426 of method 400 describe generally a method ensuring that the viewer pays attention to advertisement content by pausing the advertisement content when the viewer attention level falls below a threshold attention level. In some embodiments, that behavior may not be desired. According, referring back to block 418, in some embodiments (not illustrated) the video-on-demand application module 202 may play back the entire advertisement content and then the method 400 may advance directly to block 428.

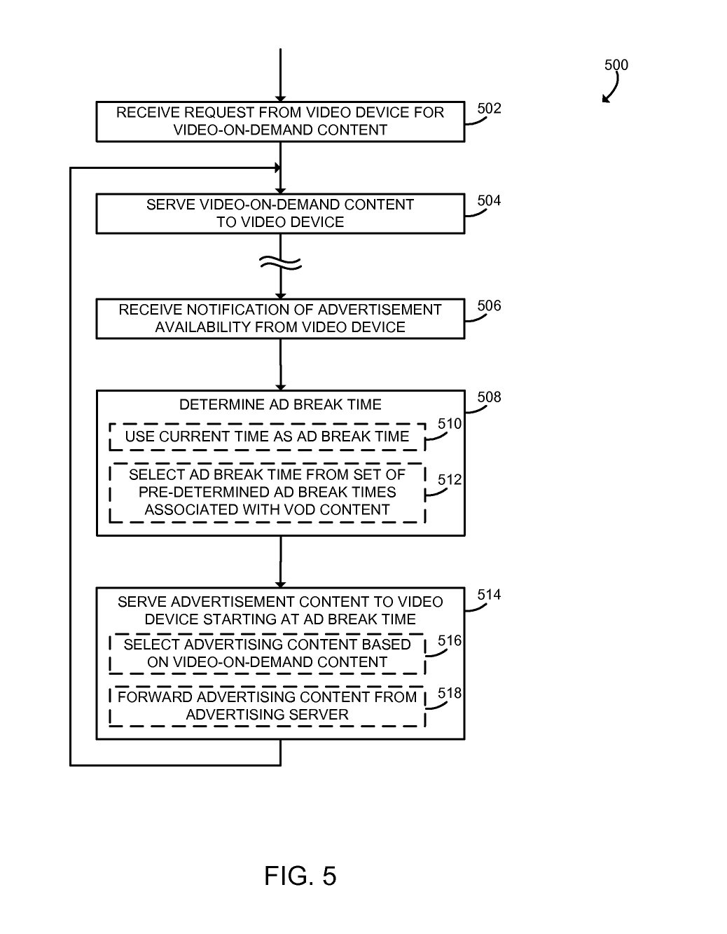

Referring now to FIG. 5, in use, the video-on-demand server 104 may execute a method 500 for timing advertisement breaks based on viewer attention level. The method 500 begins with block 502, in which the video content management module 302 receives a request for video content from the video device 102. As discussed above in connection with block 404, the request for video content may correspond to a video-on-demand program selected by a viewer, or may correspond to a segment of such video-on-demand program.

In block 504, the video content management module 302 serves the video content to the video device 102. As discussed above in connection with block 404, the video content may be streamed across the network 108 to the video device 102, or may be transferred in its entirety to the video device 102.

In block 506, the video content management module 302 receives a notification of an availability for an advertisement from the video device 102. Such notification may be received some time after the video-on-demand server 104 has begun serving video content to the video device 102. Such notification indicates that the attention level of the viewer exceeds the threshold attention level.

In response to receiving the notification from the video device 102, the method 500 advances to block 508, in which the advertisement break timing module 304 determines an advertisement break time. The advertisement break timing module 304 may employ several strategies for determining the advertisement break time. In block 510, the advertisement break timing module 304 uses the current time as the advertisement break time. Such strategy may be simple to implement, as no additional processing is necessary. However, much video content may not be amenable to advertisement breaks at essentially arbitrary times. In block 512, the advertisement break timing module 304 selects an advertisement break time from a set of pre-determined advertisement break times associated with the video content. For example, the pre-determined break times may correspond to advertisement breaks in traditional broadcast television programs. In other examples, the pre-determined break times may correspond to scene breaks in the video content. More generally, in other embodiments, the advertisement break timing module 304 may determine the advertisement break time as a function of the video content. For example, the advertisement break timing module 304 may analyze the video content to determine scene breaks.

In block 514, the advertisement content management module 306 serves the advertisement content to the video device 102 at the determined advertisement break time. In other embodiments (not illustrated), the advertisement content management module 306 commands the video device 102 to play back the selected advertisement content at the determined break time, which advertisement content was previously downloaded by the video device 102. The advertisement content management module 306 selects the advertisement content prior to serving the content to the video device 102. In some embodiments, the advertisement content management module 306 may select advertisement content from a pre-defined set of advertisement content. In block 516, in some embodiments the advertisement content management module 306 selects advertisement content based on the video content. For example, the advertisement content management module 306 may search for relevant advertisement content based on keywords extracted from the video content or associated metadata. In block 518, in some embodiments the advertisement content management module 306 forwards advertisement content from the advertisement server 106 to the video device 102. As discussed above, in some embodiments (not illustrated) the advertisement server 106 may deliver the advertisement content directly to the video device 102.

After the advertisement content has been served to the video device 102 in block 514, the method 500 loops back to block 504 to continue serving video content to the video device 102.

### EXAMPLES

Illustrative examples of the devices and methods disclosed herein are provided below. An embodiment of the devices and methods may include any one or more, and any combination of, the examples described below.

Example 1 includes a video device having a video-on-demand application module to (i) request video content from a video content server and (ii) play the video content received from the video content server in response to the request; a biometric sensor to generate biometric data indicative of an attention level of a viewer of the video content; a biometric data analysis module to receive the biometric data from the biometric sensor while the video content is being played, and a viewer attention determination module to (i) determine the viewer attention level as a function of the biometric data, (ii) compare the viewer attention level to a threshold attention level, and (iii) determine whether the viewer attention level has a predetermined relationship with the threshold attention level, wherein the video-on-demand application module is further to (i) notify the video content server of an availability for an advertisement in response to the viewer attention determination module determining the viewer attention level has the predetermined relationship with the threshold attention level and (ii) play advertisement content received from the video content server in response to the notification.

Example 2 includes the subject matter of Example 1, and wherein the viewer attention determination module is to determine whether the viewer attention level has the predetermined relationship with the threshold attention level by determining whether the viewer attention level exceeds the threshold attention level.

Example 3 includes the subject matter of any of Examples 1 and 2, and wherein the biometric sensor comprises a camera, and the biometric data comprises facial recognition data.

Example 4 includes the subject matter of any of Examples 1-3, and wherein the viewer attention determination module is to determine the viewer attention level by determining whether the viewer is present, relative to the video device, as a function of the facial recognition data.

Example 5 includes the subject matter of any of Examples 1-4, and wherein the viewer attention determination module is to determine the viewer attention level by determining a facial expression of the viewer as a function of the facial recognition data.

Example 6 includes the subject matter of any of Examples 1-5, and wherein the biometric sensor comprises an eye tracking sensor and the biometric data comprises eye tracking data, the eye tracking data being indicative of a portion of the video content on which eyes of the viewer are directed.

Example 7 includes the subject matter of any of Examples 1-6, and wherein the biometric sensor comprises a microphone and the biometric data comprises audio data.

Example 8 includes the subject matter of any of Examples 1-7, and wherein the biometric data analysis module is further to receive, while the advertisement content is playing, second biometric data indicative of the attention level of the viewer; the viewer attention determination module is further to (i) determine a second viewer attention level as a function of the second biometric data, (ii) compare the second viewer attention level to the threshold attention level, and (iii) determine whether the second viewer attention level has a second predetermined relationship with the threshold attention level; and the video-on-demand application module is further to pause the advertisement content in response to the viewer attention determination module determining the second viewer attention level has the second predetermined relationship with the threshold attention level.

Example 9 includes the subject matter of any of Examples 1-8, and wherein the viewer attention determination module is to determine whether the second viewer attention level has the second predetermined relationship with the threshold attention level by determining whether the second viewer attention level does not exceed the threshold attention level.

Example 10 includes a video content server including a video content management module to (i) receive a request for video content from a video device and (ii) serve the video content to the video device in response to the request; an advertisement break timing module to (i) receive from the video device a notification of an availability for an advertisement, the notification indicative that an attention level of a viewer of the video content has a predefined relationship with a threshold attention level, and (ii) determine an advertisement break time in response to receiving the notification of availability for an advertisement; and an advertisement content management module to serve advertisement content to the video device, the advertisement content to be displayed on the video device at the determined advertisement break time.

Example 11 includes the subject matter of any of Example 10, and wherein the advertisement break timing module is to determine the advertisement break time by determining a current time.

Example 12 includes the subject matter of any of Examples 10 and 11, and wherein the advertisement break timing module is to determine the advertisement break time by selecting an advertisement break time from a set of pre-defined advertisement break times associated with the video content.

Example 13 includes the subject matter of any of Examples 10-12, and wherein the advertisement break timing module is to determine the advertisement break time as a function of the video content.

Example 14 includes the subject matter of any of Examples 10-13, and wherein the advertisement content management module is to serve the advertisement content by selecting the advertisement content as a function of the video content.

Example 15 includes the subject matter of any of Examples 10-14, and wherein the advertisement content management module is to serve the advertisement content by forwarding the advertisement content from an advertisement server.

Example 16 includes the subject matter of any of Examples 10-15, and wherein the advertisement content management module is further to transmit instructions to the video device, the instructions to identify the advertisement break time and command the video device to play the advertisement content at the advertisement break time.

Example 17 includes a method to improve advertisement timing on a video device. The method includes playing, on the video device, video content received from a video content server in response to a request for the video content from the video device; receiving, on the video device while playing the video content, biometric data indicative of an attention level of a viewer of the video content; determining, on the video device, the viewer attention level as a function of the biometric data; comparing, on the video device, the viewer attention level to a threshold attention level; notifying the video content server of an availability for an advertisement in response to determining the viewer attention level has a predetermined relationship with the threshold attention level; and playing, on the video device, advertisement content received from the video content server in response to notifying the video content server of the availability for an advertisement.

Example 18 includes the subject matter of Example 17, and wherein determining the viewer attention level has the predetermined relationship with the threshold attention level comprises determining the viewer attention level exceeds the threshold attention level.

Example 19 includes the subject mater of any of Examples 17 and 18, and wherein receiving the biometric data comprises receiving the biometric data generated by a biometric sensor.

Example 20 includes the subject matter of any of Examples 17-19, and wherein receiving the biometric data comprises receiving facial recognition data from a camera.

Example 21 includes the subject matter of any of Examples 17-2[0073], and wherein determining the viewer attention level comprises determining whether the viewer is present, relative to the video device, as a function of the facial recognition data.

Example 22 includes the subject matter of any of Examples 17-21, and wherein determining the viewer attention level comprises determining a facial expression of the viewer as a function of the facial recognition data.

Example 23 includes the subject matter of any of Examples 17-22, and wherein receiving the biometric data comprises receiving eye tracking data from an eye tracking sensor, the eye tracking data being indicative of a portion of the video content on which eyes of the viewer are directed.

Example 24 includes the subject matter of any of Examples 17-23, and wherein receiving the biometric data comprises receiving audio data from a microphone.

Example 25 includes the subject matter of any of Examples 17-24, and further includes receiving, on the video device while playing the advertisement content, second biometric data indicative of the attention level of the viewer; determining, on the video device, a second viewer attention level as a function of the second biometric data; comparing, on the video device, the second viewer attention level to the threshold attention level; and pausing the advertisement content in response to determining the second viewer attention level has a second predetermined relationship with the threshold attention level.

Example 26 includes the subject matter of any of Examples 17-25, and wherein determining the second viewer attention level has the second predetermined relationship with the threshold attention level comprises determining the second viewer attention level does not exceed the threshold attention level.

Example 27 includes the subject matter of any of Examples 17-26, and wherein receiving the second biometric data comprises receiving the second biometric data generated by a biometric sensor.

Example 28 includes a method for a video content server to deliver advertising to a video device. The method includes comprising receiving, on the video content server, a request for video content from the video device; serving the video content from the video content server to the video device in response to the request; receiving, on the video content server, a notification of an availability for an advertisement from the video device, the notification indicative of an attention level of a viewer of the video content having a predefined relationship with a threshold attention level; determining, on the video content server, an advertisement break time in response to receiving the notification of availability for an advertisement; and serving advertisement content from the video content server to the video device, the advertisement content to be displayed on the video device at the determined advertisement break time.

Example 29 includes the subject matter of Example 28, and wherein determining the advertisement break time comprises determining a current time.

Example 30 includes the subject matter of any of Examples 28 and 29, and wherein determining the advertisement break time comprises selecting an advertisement break time from a set of pre-defined advertisement break times associated with the video content.

Example 31 includes the subject matter of any of Examples 28-30, and wherein determining the advertisement break time comprises determining the advertisement break time as a function of the video content.

Example 32 includes the subject matter of any of Examples 28-31, and wherein serving the advertisement content comprises selecting the advertisement content as a function of the video content.

Example 33 includes the subject matter of any of Examples 28-32, and wherein serving the advertisement content comprises forwarding the advertisement content from an advertisement server.

Example 34 includes the subject matter of any of Examples 28-33, and further includes transmitting instructions from the video content server to the video device, the instructions identifying the advertisement break time and commanding the video device to play the advertisement content at the advertisement break time.

Example 35 includes a computing device comprising a processor; and a memory having stored therein a plurality of instructions that when executed by the processor cause the computing device to perform the method of any of Examples 17-34.

Example 36 includes one or more machine readable storage media comprising a plurality of instructions stored thereon that in response to being executed result in a computing device performing the method of any of Examples 17-35.

1. A video device, comprising:
a video-on-demand application module to (i) request video content from a video content server and (ii) play the video content received from the video content server in response to the request;
a biometric sensor to generate biometric data indicative of whether or not a viewer is viewing the video content;
a biometric data analysis module to (i) receive the biometric data from the biometric sensor while the video content is being played, and (ii) determine a viewing duration for which the viewer is viewing the video content based on the biometric data; and
a viewer attention determination module to (i) determine a viewer attention level as a function of the viewing duration determined by the biometric data analysis module, (ii) compare the viewer attention level to a threshold attention level, and (iii) determine whether the viewer attention level has a predetermined relationship with the threshold attention level, wherein:
the video-on-demand application module is further to (i) notify the video content server of an availability for an advertisement in response to the viewer attention determination module determining the viewer attention level has the predetermined relationship with the threshold attention level and (ii) play advertisement content received from the video content server in response to the notification.

2. The video device of claim 1, wherein the viewer attention determination module is to determine whether the viewer attention level has the predetermined relationship with the threshold attention level by determining whether the viewer attention level exceeds the threshold attention level.

3. The video device of claim 1, wherein the biometric sensor comprises one of: a camera, an eye tracking sensor, and a microphone.

4. The video device of claim 3, wherein the biometric data comprises facial recognition data and the viewer attention determination module is to determine the viewer attention level by one of: determining whether the viewer is present, relative to the video device, as a function of the facial recognition data and determining a facial expression of the viewer as a function of the facial recognition data.

5. The video device of claim 1, wherein:
the biometric data analysis module is further to (i) receive, while the advertisement content is playing, second biometric data indicative of whether or not the viewer is viewing the advertisement content, and (ii) determine a second viewing duration for which the viewer is viewing the advertisement content based on the second biometric data;
the viewer attention determination module is further to (i) determine a second viewer attention level as a function of the second viewing duration, (ii) compare the second viewer attention level to the threshold attention level, and (iii) determine whether the second viewer attention level has a second predetermined relationship with the threshold attention level; and
the video-on-demand application module is further to pause the advertisement content in response to the viewer attention determination module determining the second viewer attention level has the second predetermined relationship with the threshold attention level.

6. The video device of claim 5, wherein the viewer attention determination module is to determine whether the second viewer attention level has the second predetermined relationship with the threshold attention level by determining whether the second viewer attention level does not exceed the threshold attention level.

7. A video content server, comprising:
a video content management module to (i) receive a request for video content from a video device and (ii) serve the video content to the video device in response to the request;
an advertisement break timing module to (i) receive from the video device a notification of an availability for an advertisement, the notification indicative that the video device has determined that an attention level of a viewer of the video content has a predefined relationship with a threshold attention level as a function of a viewing duration for which the viewer is viewing the video content based on biometric data received by the video device from a biometric sensor of the video device, the biometric data indicative of whether or not the viewer is viewing the video content, and (ii) determine an advertisement break time in response to receiving the notification of availability for an advertisement; and
an advertisement content management module to serve advertisement content to the video device, the advertisement content to be displayed on the video device at the determined advertisement break time.

8. The video content server of claim 7, wherein the advertisement break timing module is to determine the advertisement break time by one of: determining a current time, selecting the advertisement break time from a set of pre-defined advertisement break times associated with the video content, and determining the advertisement break time as a function of the video content.

9. The video content server of claim 7, wherein the advertisement content management module is further to transmit instructions to the video device, the instructions to identify the advertisement break time and command the video device to play the advertisement content at the advertisement break time.

10. A method to improve advertisement timing on a video device, the method comprising:
playing, on the video device, video content received from a video content server in response to a request for the video content from the video device;
receiving, on the video device while playing the video content, biometric data indicative of whether or not a viewer is viewing the video content;
determining, on the video device, a viewing duration for which the viewer is viewing the video content based on the biometric data;
determining, on the video device, the viewer attention level as a function of the viewing duration;
comparing, on the video device, the viewer attention level to a threshold attention level;
notifying the video content server of an availability for an advertisement in response to determining the viewer attention level has a predetermined relationship with the threshold attention level; and
playing, on the video device, advertisement content received from the video content server in response to notifying the video content server of the availability for an advertisement.

11. The method of claim 10, wherein determining the viewer attention level has the predetermined relationship with the threshold attention level comprises determining the viewer attention level exceeds the threshold attention level.

12. The method of claim 10, wherein receiving the biometric data comprises one of: receiving facial recognition data from a camera, receiving eye tracking data from an eye tracking sensor, the eye tracking data being indicative of a portion of the video content on which eyes of the viewer are directed, and receiving audio data from a microphone.

13. The method of claim 12, wherein determining the viewer attention level comprises one of: determining whether the viewer is present, relative to the video device, as a function of the facial recognition data and determining a facial expression of the viewer as a function of the facial recognition data.

14. The method of claim 10, further comprising:
receiving, on the video device while playing the advertisement content, second biometric data indicative of whether or not the viewer is viewing the advertisement content;
determining, on the video device, a second viewing duration for which the viewer is viewing the advertisement content based on the second biometric data;
determining, on the video device, a second viewer attention level as a function of the second viewing duration;
comparing, on the video device, the second viewer attention level to the threshold attention level; and
pausing the advertisement content in response to determining the second viewer attention level has a second predetermined relationship with the threshold attention level.

15. The method of claim 14, wherein determining the second viewer attention level has the second predetermined relationship with the threshold attention level comprises determining the second viewer attention level does not exceed the threshold attention level.

16. One or more non-transitory, machine readable storage media comprising a plurality of instructions that in response to being executed result in a computing device:
playing, on a video device, video content received from a video content server in response to a request for the video content from the video device;
receiving, on the video device while playing the video content, biometric data indicative of whether or not a viewer is viewing the video content;
determining, on the video device, a viewing duration for which the viewer is viewing the video content based on the biometric data;
determining, on the video device, the viewer attention level as a function of the viewing duration;
comparing, on the video device, the viewer attention level to a threshold attention level;
notifying the video content server of an availability for an advertisement in response to determining the viewer attention level has a predetermined relationship with the threshold attention level; and
playing, on the video device, advertisement content received from the video content server in response to notifying the video content server of the availability for an advertisement.

17. The one or more machine readable storage media of claim 16, wherein determining the viewer attention level has the predetermined relationship with the threshold attention level comprises determining the viewer attention level exceeds the threshold attention level.

18. The one or more machine readable storage media of claim 16, wherein receiving the biometric data comprises one of: receiving facial recognition data from a camera, receiving eye tracking data from an eye tracking sensor, the eye tracking data being indicative of a portion of the video content on which eyes of the viewer are directed, and receiving audio data from a microphone.

19. The one or more machine readable storage media of claim 18, wherein determining the viewer attention level comprises one of: determining whether the viewer is present, relative to the video device, as a function of the facial recognition data and determining a facial expression of the viewer as a function of the facial recognition data.

20. The one or more machine readable storage media claim 16, further comprising a plurality of instructions that in response to being executed result in the computing device:
receiving, on the video device while playing the advertisement content, second biometric data indicative of whether or not the viewer is viewing the advertisement content;
determining, on the video device, a second viewing duration for which the viewer is viewing the advertisement content based on the second biometric data;
determining, on the video device, a second viewer attention level as a function of the second viewing duration;
comparing, on the video device, the second viewer attention level to the threshold attention level; and
pausing the advertisement content in response to determining the second viewer attention level has a second predetermined relationship with the threshold attention level.

21. The one or more machine readable storage media claim 20, wherein determining the second viewer attention level has the second predetermined relationship with the threshold attention level comprises determining the second viewer attention level does not exceed the threshold attention level.
